(19) United States
(12) Patent Application Publication
(10) Pub. No.: US 2015/0329783 A1
(43) Pub. Date: Nov. 19, 2015

(54) METHOD OF MANUFACTURING MICROENCAPSULATED PHASE-CHANGE MATERIAL-CONTAINING GYPSUM PLATE CAPABLE OF FLAME RETARDATION AND TEMPERATURE VARIATION ATTENUATION

(71) Applicant: NATIONAL CHUNG SHAN INSTITUTE OF SCIENCE AND TECHNOLOGY, LONGTAN TOWNSHIP (TW)

(72) Inventors: PING-SZU TSAI, KAOHSIUNG (TW); YI-HSIUAN YU, TAO-YUAN (TW); JENG-PEI HSIEH, KAOHSIUNG (TW); SHU-HUA LEE, TAO-YUAN (TW); HOU-AN HSIEH, TAO-YUAN (TW)

(73) Assignee: NATIONAL CHUNG SHAN INSTITUTE OF SCIENCE AND TECHNOLOGY, LONGTAN TOWNSHIP (TW)

(21) Appl. No.: 14/279,362

(22) Filed: May 16, 2014

(51) Int. Cl. C09K 21/14; B29C 44/34; B29C 44/02; E04B 1/78

(52) U.S. Cl. CPC C09K 21/14; E04B 1/78; B29C 44/3442; B29C 44/02; B29C 44/3415; B29K 2029/04

(57) ABSTRACT

A method of manufacturing a microencapsulated phase-change material-containing gypsum plate capable of flame retardation and temperature variation attenuation is introduced, such that an organic microencapsulated phase-change material is uniformly distributed in an inorganic gypsum plate. The method involves putting a microencapsulated phase-change material in a dispersing agent solution, blending the dispersing agent solution to form a first solution, putting the foaming agent in the first solution, putting gypsum powder and starch in the first solution, blending the first solution to form a microencapsulated phase-change material gypsum mixture solution, molding the microencapsulated phase-change material gypsum mixture solution to finalize the manufacturing of a microencapsulated phase-change material-containing gypsum plate capable of flame retardation and temperature variation attenuation. Due to the microencapsulated phase-change material, dispersing agent, and foaming agent, gas generated from the microencapsulated phase-change material heated at high temperature is quickly discharged from the gypsum plate without destructing original structure thereof.

### FIELD OF TECHNOLOGY

The present invention relates to blending techniques whereby a microencapsulated phase-change material is uniformly distributed in an inorganic gypsum plate, and more particularly, to a method of manufacturing a gypsum plate containing a dispersing agent, a foaming agent, and a microencapsulated phase-change material and thus capable of flame retardation and temperature variation attenuation.

### BACKGROUND

Conventional phase-change energy-storing materials are for use in manufacturing thermal insulation construction materials to be applied in home renovation. Conventional phase-change energy-storing materials work by heat exchange and are conducive to the enhancement of the efficiency of heat dissipation and temperature regulation. Taiwan Published Patent Application 200844308 discloses a method of manufacturing an energy-storing construction materials, wherein the manufacturing method involves mixing a phase-change energy-storing material, a blending agent, and a construction raw material fully and then introducing the energy-storing construction oriented mixture into a specific mold so as for the mixture to take shape.

The prior art discloses methods of manufacturing microencapsulated phase-change material-containing gypsum plates. Literature related to microencapsulated phase-change material-containing gypsum plates and energy-storing behavior thereof and published by local and foreign academics are briefly described as follows:

In 2009, Ching-Yao Lin, discloses mixing commercially available microencapsulated phase-change material powder and gypsum powder physically and then diluting the mixture so as to manufacture a microencapsulated phase-change material-containing gypsum plate. As revealed by an experiment, an increase (say, 23.16wt %, 40 wt %) of the concentration of the microencapsulated phase-change material in the gypsum plate does not cause any significant change to its melting point and solidifying point but reduces its density from 845.05 kg/m³ to 735.25 kg/m³, indicating that a gypsum plate which contains a phase-change material (PCM) is of a lower density than when it does not.

In 2010, Borreguero et al. discover that the nuclear shell of a microencapsulated phase-change material manifests optimal phase-change latent heat when its feed ratio equals 1.5, and its wall temperature takes 300 minutes to enter a stable state if the concentration of the microencapsulated phase-change material in the gypsum plate increases to 7.5 wt %, thereby indicating that the PCM gypsum plate is capable of lessening the fluctuation of temperature.

In 2012, Zhang et al. synthesize a microencapsulated phase-change material by in-situ polymerization and then mix microcapsule powder, gypsum powder, and fiberglass to manufacture a micro-PCMs gypsum plate. An experiment reveals that a gradual increase in the concentration of the PCM microcapsules in the gypsum plate from 30 wt % to 60 wt % causes its phase-change latent heat to increase from 39.2 J/g to 76.9 J/g and its thermal conductivity coefficient to decrease from 0.48386 W/mK to 0.1537 W/mK, thereby indicating that the PCM gypsum plate manifests thermal behavior, such as storing heat and lessening fluctuation of temperature.

In 2011, Baspinar & Kahraman and others disclose modifying the physical properties of a gypsum plate by adding thereto fine powder of 5-15 wt % of silicon dioxide, and in consequence a microscopic examination of the modified gypsum plate reveals that the modified gypsum plate has a conspicuous porous structure.

In conclusion, the introduction of a phase-change material (PCM) into a gypsum plate renders the gypsum plate capable of lessening fluctuation of temperature. However, when heated up at a high temperature, the PCM vaporizes to become gaseous for certain. If the gas is not discharged from the gypsum plate quickly, it will damage the structure of the gypsum plate, for example, rupturing the gypsum plate. Not being able to keep a high heat source at bay and thus not being effective in flame retardation, the ruptured gypsum plate is not suitable for use as an indoor construction material.

### SUMMARY

In view of the aforesaid drawbacks of the prior art, it is an objective of the present invention to provide a method of manufacturing a microencapsulated phase-change material-containing gypsum plate capable of flame retardation and temperature variation attenuation, wherein the method involves distributing a microencapsulated phase-change material in an inorganic gypsum plate uniformly to effectuate temperature variation attenuation thereof, putting a foaming agent in the gypsum plate to not only attain uniform distribution of a phase-change material (PCM) but also pores of appropriate size and quantity, so as to discharge the vaporized organic matters from the gypsum plate efficiently, keep the original structure of the gypsum plate intact at a high temperature, and enhance the flame retardation function of the gypsum plate.

In order to achieve the above and other objectives, the present invention provides a method of manufacturing a microencapsulated phase-change material-containing gypsum plate capable of flame retardation and temperature variation attenuation. The method comprises the steps of: providing a foaming agent solution; putting the phase-change microcapsules in the foaming agent aqueous solution, followed by performing thereon a first blending dispersing process to form a first solution, wherein the phase-change microcapsules and the foaming agent solution are immiscible; providing gypsum powder and starch, followed by performing the second blending dispersing process to form a second solution; putting the second solution in the first solution, followed by performing a third blending dispersing process to form a microencapsulated phase-change material gypsum mixture solution; and molding the microencapsulated phase-change material gypsum mixture solution to form a microencapsulated phase-change material-containing gypsum plate capable of flame retardation and temperature variation attenuation. Hence, pores of appropriate size and quantity are formed inside the gypsum plate, and gas generated from the phase-change material microcapsules heated at a high temperature can be quickly discharged from the gypsum plate, thereby preventing the damage otherwise caused to the original structure of the gypsum plate.

Another objective of the present invention is to provide a method of manufacturing a microencapsulated phase-change material-containing gypsum plate, wherein the blending dispersing process requires a magnetic mixer, a motor-driven agitator, or a homogenizer. The aforesaid manufacturing method involves molding, setting, and curing the microencapsulated phase-change material gypsum mixture solution and then knocking out, removing, heating, and drying the phase-change material gypsum plate. The drying process includes a four-stage temperature gradient curing process. The manufacturing method is effective in manufacturing a microencapsulated phase-change material-containing gypsum plate capable of flame retardation and temperature variation attenuation.

Yet another objective of the present invention is to provide a manufacturing method which comprises the steps of: putting a dispersing agent in a foaming agent solution; putting the phase-change microcapsules in the foaming agent solution, followed by performing a first blending dispersing process to form a first solution, wherein the phase-change microcapsules and the foaming agent solution are immiscible; providing gypsum powder and starch, followed by performing the second blending dispersing process to form a second solution; putting the second solution in the first solution, followed by performing the third blending dispersing process to form a microencapsulated phase-change material gypsum mixture solution; and molding the microencapsulated phase-change material gypsum mixture solution by performing a four-stage temperature gradient curing process, so as to manufacture a microencapsulated phase-change material-containing gypsum plate capable of flame retardation and temperature variation attenuation.

As regards the manufacturing method, wherein the foaming agent of the foaming agent aqueous solution is provided in the form of sodium dodecyl sulfate (SDS) or sodium hydrogen carbonate (NaHCO3).

As regards the manufacturing method, wherein the concentration of the foaming agent ranges from 1.67 wt % to 5 wt %.

As regards the manufacturing method, wherein the microencapsulated phase-change material is a nuclear shell material, wherein the nuclear shell material is an organic material

As regards the manufacturing method, wherein the microencapsulated phase-change material content ranges from 10 wt % to 40 wt %.

The first solution for use in the manufacturing method further comprises a dispersing agent provided in the form of a polyvinyl alcohol (PVA), and the concentration of the polyvinyl alcohol (PVA) ranges from 1 wt % to 10 wt %.

The four-stage temperature gradient curing performed during the process flow of the manufacturing method takes place at a temperature which ranges from 80° C. to 150° C.

### BRIEF DESCRIPTION

Objectives, features, and advantages of the present invention are hereunder illustrated with specific embodiments in conjunction with the accompanying drawings, in which:

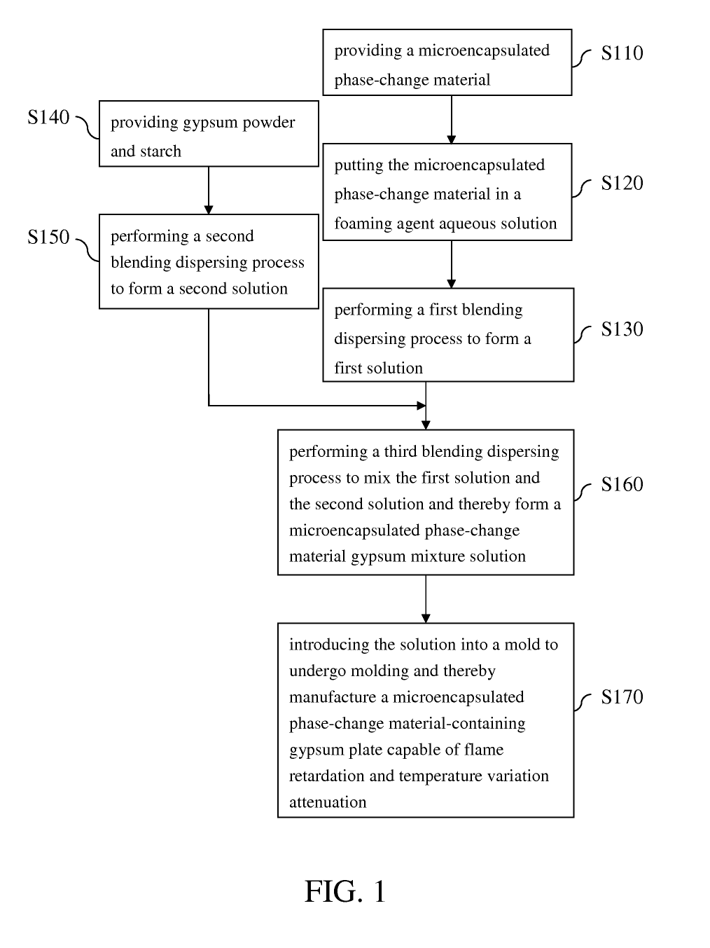

FIG. 1 is a flow chart of the process flow of a manufacturing method according to an embodiment of the present invention;

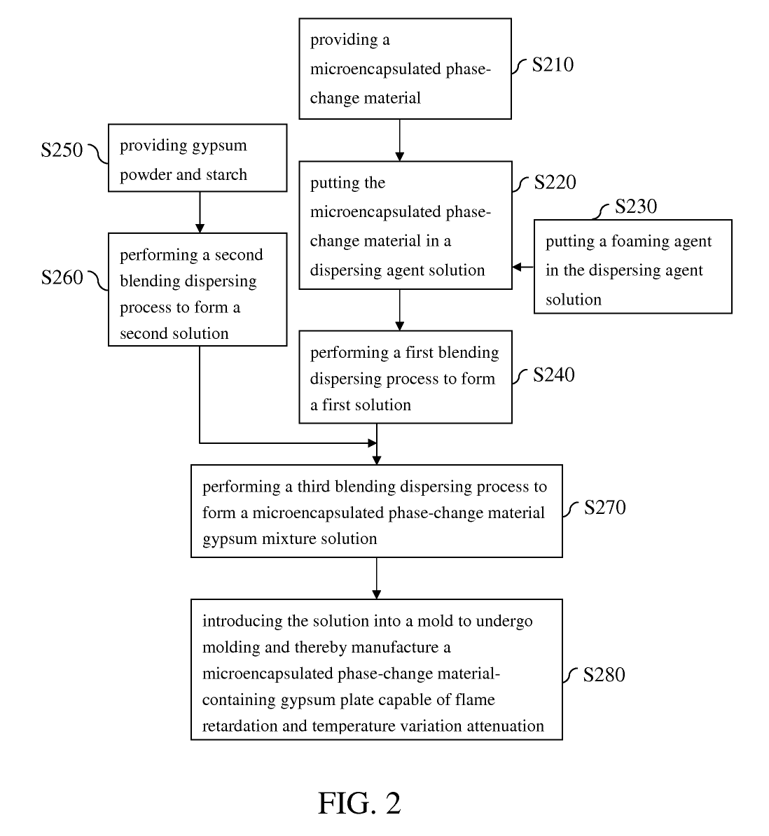

FIG. 2 is a flow chart of the process flow of the manufacturing method according to another embodiment of the present invention;

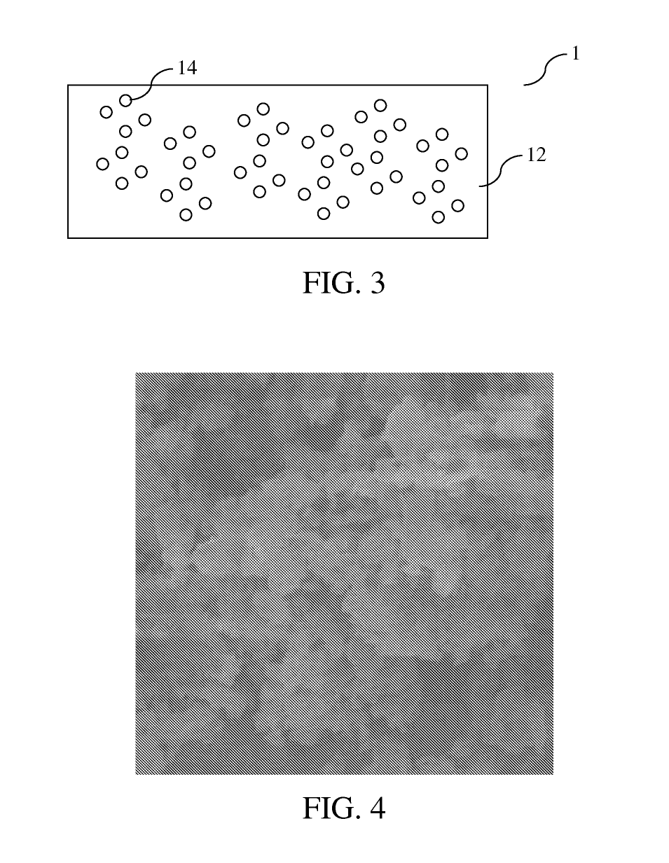

FIG. 3 is a structural schematic view of a microencapsulated phase-change material-containing gypsum plate according to the present invention;

FIG. 4 is an SEM image of a microencapsulated phase-change material-containing gypsum plate inclusive of a 1.67 wt % foaming agent according to the present invention;

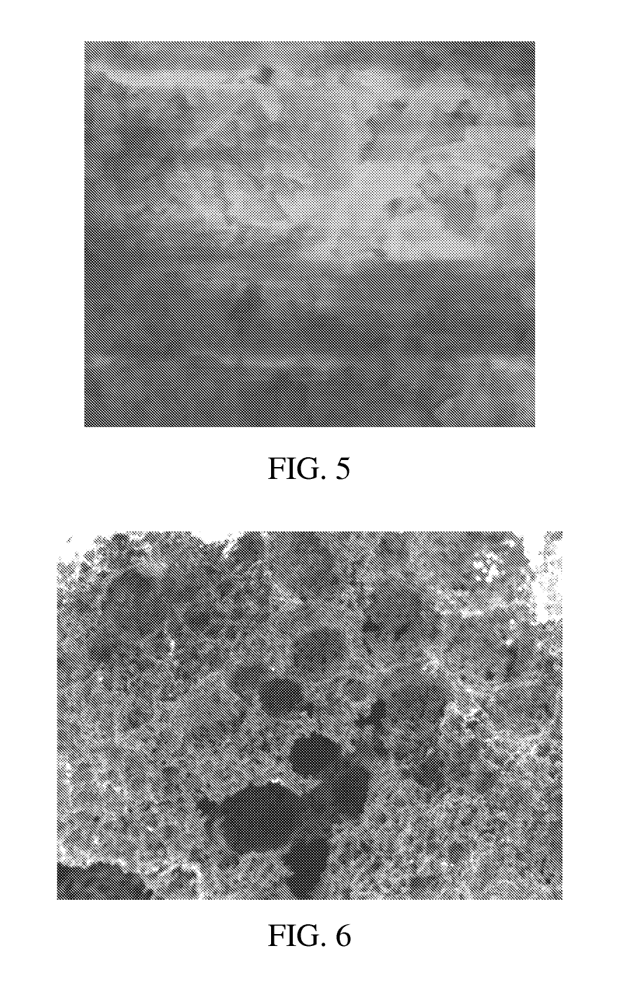

FIG. 5 is an SEM image taken by SEM-EDS of the phase-change material-containing gypsum plate manufactured from 3.8 wt % of polyvinyl alcohol (PVA) and analyzed by element image analysis; and

FIG. 6 is an SEM image taken of the microencapsulated phase-change material-containing gypsum plate which contains 3.8 wt % of polyvinyl alcohol (PVA) and a 1.67 wt % foaming agent and undergoes sintering at 1000° C. for 60 minutes according to embodiment 2 of the present invention, and the SEM image reveals a porous structure of the gypsum plate observed at 100× magnification power.

### DETAILED DESCRIPTION

Referring to FIG. 1, there is shown a flow chart of the process flow of a manufacturing method according to an embodiment of the present invention. As shown in the diagram, the method comprises the steps of: providing a microencapsulated phase-change material (S110); putting the microencapsulated phase-change material in a foaming agent aqueous solution (S120); performing a first blending dispersing process to form a first solution (S130); providing gypsum powder and starch (S140); performing a second blending dispersing process to form a second solution (S150); performing a third blending dispersing process to mix the first solution and the second solution and thereby form a microencapsulated phase-change material gypsum mixture solution (S160); and introducing the solution into a mold to undergo molding and thereby manufacture a microencapsulated phase-change material-containing gypsum plate capable of flame retardation and temperature variation attenuation (S170).

Referring to FIG. 2, there is shown a flow chart of the process flow of the manufacturing method according to another embodiment of the present invention. As shown in the diagram, the method comprises the steps of: providing a microencapsulated phase-change material (S210); putting the microencapsulated phase-change material in a dispersing agent solution (S220); putting a foaming agent in the dispersing agent solution (S230); performing a first blending dispersing process to form a first solution (S240); providing gypsum powder and starch (S250); performing a second blending dispersing process to form a second solution (S260); mixing the first solution and the second solution, followed by performing a third blending dispersing process to form a microencapsulated phase-change material gypsum mixture solution (S270); and introducing the solution into a mold to undergo molding and thereby manufacture a microencapsulated phase-change material-containing gypsum plate capable of flame retardation and temperature variation attenuation (S280).

In the embodiment of the present invention, the manufacturing method comprises the steps of: providing a water-soluble polymer polyvinyl alcohol (PVA) aqueous solution; providing an organic microencapsulated phase-change material (PCM) powder; providing a gypsum powder; providing a starch; and providing a foaming agent. The aforesaid steps are described in details as follows:
A. Prepare 3.4 wt % to 5 wt % of polyvinyl alcohol (PVA) aqueous solution.
B. Put the microencapsulated phase-change material powder in the aqueous solution of step A and then stir the aqueous solution with a magnet for 30 minutes and at a rotation speed of 300 rpm, such that the microencapsulated phase-change material powder mixes with PVA.
C. Put a 1.67 wt % to 5 wt % foaming agent in the aqueous solution of step B and then stir the aqueous solution with a magnet for 40 minutes to prepare a microencapsulated aqueous solution.
D. Mix gypsum powder and starch and then put the mixture in the microencapsulated aqueous solution of step C. Then, stir the microencapsulated aqueous solution mechanically for 120 seconds and at a rotation speed of 400 rpm.
E. The microencapsulated aqueous solution of step D is molded and set.
F. After the phase-change material (PCM) gypsum plate in the mold has cured, knock out the PCM gypsum plate and then put it in a baker to dry it at 140° C. for one hour, cool it to 120° C. for one hour, cool it to 100° C. for two hours, and eventually cool it to 50° C. for 24 hours. Due to the aforesaid four-stage temperature gradient, the manufacturing of the microencapsulated phase-change material-containing gypsum plate is finalized.

Step A of the process flow of the manufacturing method entails preparing a polyvinyl alcohol aqueous solution and then performing step B to introduce the microencapsulated phase-change material powder and mix them fully to prepare an evenly dispersed solution. Furthermore, in step D, the gypsum powder and the starch are mixed fully before being added to the microencapsulated aqueous solution of step C. The order in which the aforesaid two steps are performed is of vital importance and thus must be strictly followed, otherwise the microencapsulated phase-change material is likely to aggregate within the gypsum plate to the detriment of uniform distribution and thus render the microencapsulated phase-change material-containing gypsum plate less effective in temperature variation attenuation. The polyvinyl alcohol aqueous solution content preferably equals 5 wt %.

Referring to FIG. 3, there is shown a structural schematic view of a microencapsulated phase-change material-containing gypsum plate 1 according to the present invention. As shown in the diagram, the microencapsulated phase-change material-containing gypsum plate 1 is characterized in that a microencapsulated phase-change material 14 is uniformly distributed in a gypsum plate 12. The aforesaid manufacturing method is characterized in that the microencapsulated phase-change material and the polyvinyl alcohol aqueous solution are mixed fully and then a foaming agent is put in the mixture, such that pores of appropriate sizes are formed in the PCM gypsum plate capable of flame retardation. The concentration of the foaming agent ranges from 1.6 wt % to 5 wt % and preferably equals 1.67 wt %.

The foaming agent has a constant concentration of 1.67 wt % throughout the process flow of the manufacturing method. If the concentration of the polyvinyl alcohol and the foaming agent is overly high, the PCM gypsum plate cannot set to form a gypsum plate in 30 minutes. Hence, the concentration of the polyvinyl alcohol has to be adjusted, that is, reducing the concentration of the polyvinyl alcohol to 3.8 wt % such that the PCM gypsum plate can set in 30 minutes without compromising the uniform distribution thereof If the concentration of the polyvinyl alcohol is increased to 5.0 wt %, the time the gypsum plate takes to set will have to be extended to 50 minutes. In view of this, the preferred concentration of the polyvinyl alcohol is 3.8 wt %, and the preferred concentration of the foaming agent is 1.67 wt %. Hence, the present invention is advantageously characterized in that: the PCM gypsum plate still looks pleasant even at a high temperature; and the gypsum plate is unlikely to rupture, even though the PCM within the gypsum plate decomposes and vaporizes.

The concentration of the dispersing agent and the concentration of the foaming agent when mixed are illustrated with the embodiments described hereunder.

### Embodiment 1

The process flow of the manufacturing method comprises the steps of: preparing a 5 wt % PVA aqueous solution; putting a microencapsulated phase-change material (PMMA covered n-octadecane) in the 5 wt % PVA aqueous solution, followed by stirring the 5 wt % PVA aqueous solution with a magnet for 30 minutes and at a rotation speed of 300 rpm until the microencapsulated phase-change material and the 5 wt % PVA aqueous solution are fully mixed; putting a 1.67 wt % foaming agent (provided in the form of sodium dodecyl sulfate (SDS)) in the mixture, followed by stirring the 1.67 wt % foaming agent and the mixture with a magnet for 40 minutes; mixing gypsum powder and starch, putting the mixture of the gypsum powder and starch in the microencapsulated aqueous solution, and stirring the gypsum powder-containing and starch-containing microencapsulated aqueous solution mechanically for 120 seconds and at a rotation speed of 400 rpm; putting the gypsum powder-containing and starch-containing microencapsulated aqueous solution in a mold to mold and set the gypsum powder-containing and starch-containing microencapsulated aqueous solution for 50 minutes; knocking out and removing the cured PCM gypsum plate, followed by putting the cured PCM gypsum plate in a baker to dry it at 140° C. for one hour, at 120° C. for one hour, at 100° C. for two hours, and eventually at 50° C. for 24 hours, so as to finalize the manufacturing of the microencapsulated phase-change material-containing gypsum plate according to the present invention.

### Embodiment 2

The process flow of the manufacturing method comprises the steps of: preparing a 3.8 wt % PVA aqueous solution; putting a microencapsulated phase-change material (PMMA covered n-octadecane) in the 3.8 wt % PVA aqueous solution, followed by stirring the 3.8 wt % PVA aqueous solution with a magnet for 30 minutes and at a rotation speed of 300 rpm until the microencapsulated phase-change material and the 3.8 wt % PVA aqueous solution are fully mixed; putting a 1.67 wt % foaming agent (provided in the form of sodium dodecyl sulfate (SDS)) in the mixture, followed by stirring the 1.67 wt % foaming agent and the mixture with a magnet for 40 minutes; mixing gypsum powder and starch, putting the mixture of the gypsum powder and starch in the microencapsulated aqueous solution, and stirring the gypsum powder-containing and starch-containing microencapsulated aqueous solution mechanically for 120 seconds and at a rotation speed of 400 rpm; putting the gypsum powder-containing and starch-containing microencapsulated aqueous solution in a mold to mold and set the gypsum powder-containing and starch-containing microencapsulated aqueous solution for 20 min; knocking out and removing the cured PCM gypsum plate, followed by putting the cured PCM gypsum plate in a baker to dry it at 140° C. for one hour, at 120° C. for one hour, at 100° C. for two hours, and eventually at 50° C. for 24 hours, so as to finalize the manufacturing of the microencapsulated phase-change material-containing gypsum plate according to the present invention.

In two variant embodiments of the present invention, a foaming agent-containing microencapsulated phase-change material-containing gypsum plate and a foaming agent-free microencapsulated phase-change material-containing gypsum plate are sintered at 1000° C. (when heated up at 10° C. per minute to reach 1000° C., and then sintered at the constant temperature of 1000° C. for one hour), the gypsum plate is examined and screened for a rupture. The gypsum plate examination and screen reveals that the foaming agent-free gypsum plate ruptures, whereas the foaming agent-containing gypsum plate remains intact, as described in the table below.

| microencapsulated | | |
|---|---|---|
| phase-change | | |
| material-containing | not sintered at | sintered at |
| gypsum plate | 1000 C ° | 1000 C ° |
| foaming agent-free | not ruptured | ruptured |
| foaming agent-containing | not ruptured | not ruptured |

Referring to FIG. 4, there is shown a scanning electron microscope and energy dispersive spectrometer (SEM-EDS) of the PCM gypsum plate manufactured from 5 wt % of polyvinyl alcohol (PVA) and analyzed by element image analysis, which indicates that the microencapsulated phase-change material is uniformly distributed in the gypsum plate. Referring to FIG. 5, there is shown an SEM image taken by SEM-EDS of the phase-change material-containing gypsum plate manufactured from 3.8 wt % of polyvinyl alcohol (PVA) and analyzed by element image analysis, indicating that the microencapsulated phase-change material is uniformly distributed in the gypsum plate, wherein the setting duration equals 30 minutes or less.

Referring to FIG. 6, there is shown an SEM image taken of the microencapsulated phase-change material-containing gypsum plate which contains 3.8 wt % of polyvinyl alcohol (PVA) and a 1.67 wt % foaming agent and undergoes sintering at 1000° C. for 60 minutes according to embodiment 2 of the present invention, and the SEM image reveals a porous structure of the gypsum plate observed at 100× magnification power. The SEM image shows large pores each of a diameter of 200 μm approximately and small pores each of a diameter of 5 μm approximately. The large pores are formed because of the foaming agent and the air introduced during the stirring process. The small pores are formed as a result of the combustion of microcapsules. The microcapsules are in communication with each other regardless of their sizes; hence, as soon as the microcapsules decompose and vaporize at a high temperature, the resultant gaseous environment ensures that organic substances can be gradually discharged from the gypsum plate, such that not only does the porous structure of the gypsum plate remain intact, but the gypsum plate is also prevented from rupturing.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method of manufacturing a microencapsulated phase-change material-containing gypsum plate capable of flame retardation and temperature variation attenuation, the method comprising the steps of:
A. providing a foaming agent aqueous solution;
B. putting a microencapsulated phase-change material in the foaming agent aqueous solution, followed by performing thereon a first blending dispersing process to form a first solution, wherein the microencapsulated phase-change material and the foaming agent aqueous solution are immiscible;
C. providing gypsum powder and starch, followed by performing a second blending dispersing process to form a second solution;
D. putting the second solution in the first solution, followed by performing a third blending dispersing process to form a microencapsulated phase-change material gypsum mixture solution; and
E. molding the microencapsulated phase-change material gypsum mixture solution to form a microencapsulated phase-change material-containing gypsum plate capable of flame retardation and temperature variation attenuation.

2. The method of claim 1, wherein the foaming agent of the foaming agent aqueous solution comprises one of sodium dodecyl sulfate (SDS) and sodium hydrogen carbonate (NaHCO₃).

3. The method of claim 2, wherein concentration of the foaming agent ranges from 1.67 wt % to 5 wt %.

4. The method of claim 1, wherein the microencapsulated phase-change material is a nuclear shell material, wherein the nuclear shell material is an organic material.

5. The method of claim 1, wherein the microencapsulated phase-change material content ranges from 10 wt % to 40 wt %.

6. The method of claim 1, wherein step B further requires a dispersing agent provided in form of a polyvinyl alcohol (PVA), and concentration of the PVA ranges from 1 wt % to 10 wt %.

7. The method of claim 1, wherein the first blending dispersing process, the second blending dispersing process, and the third blending dispersing process are performed with one of a magnetic mixer, a motor-driven agitator, and a homogenizer.

8. The method of claim 1, wherein the molding of the microencapsulated phase-change material gypsum mixture solution in step E entails putting the microencapsulated phase-change material gypsum mixture solution in a mold to mold and set the microencapsulated phase-change material gypsum mixture solution.

9. The method of claim 1, wherein step E entails molding, setting, and curing the microencapsulated phase-change material gypsum mixture solution and then knocking out, removing, heating, and drying the phase-change material gypsum plate.

10. The method of claim 1, wherein the step (E) entails performing four-stage temperature gradient curing.

11. The method of claim 10, wherein the four-stage temperature gradient curing takes place at 80° C. to 150° C.
